(19) United States
(12) Patent Application Publication
(10) Pub. No.: US 2017/0038504 A1
(43) Pub. Date: Feb. 9, 2017

(54) CLOSE-UP SHOTS SYSTEM AND CLOSE-UP SHOTS MODULE

(71) Applicant: LUSTROUS ELECTRO-OPTIC CO., LTD., New Taipei City (TW)

(72) Inventor: CHIH-WEI TSAI, HSINCHU CITY (TW)

(21) Appl. No.: 14/818,368

(22) Filed: Aug. 5, 2015

(51) Int. Cl. G02B 3/14; G02B 13/24; G02B 13/00; H04N 5/225; H04N 5/232

(52) U.S. Cl. CPC G02B 3/14; H04N 5/2256; H04N 5/23212; G02B 13/0075; G02B 13/24

(57) ABSTRACT

The instant disclosure provides a close-up shots module which corresponds to an image capture module of an electronic device to capture an object image. The close-up shots module has a liquid lens unit and a control unit. The control unit is electrically connected to the liquid lens unit. Wherein the control unit on the basis of a signal from the image capture module adjusts the focal length of the liquid lens unit. The instant disclosure also provides a close-up shots system.

### BACKGROUND OF THE INVENTION

1. Field of the Invention

The instant disclosure relates to an image capture system; in particular, to a close-up shots system and a close-up shots module thereof.

2. Description of Related Art

With the development of technology, electric devices such as smart phones, tablet computers, and the like, have more and more functions. In addition to dialing, the mobile electric device can capture images. Moreover, due to consumer requirements, electric devices have gotten thinner, lighter and much more portable. Thus, consumers have gotten used to capturing images via these portable electric devices.

Currently, these electric devices generally use passive automatic focusing technology, and every electric device only has one predetermined depth of field, which only applies to capturing general images of objects but not to capturing images of the object within a very short distance, because of insufficient magnifying power. Moreover, when capturing an image in a very short distance, it is hard to be properly focused because of the features of the lens module.

In order to solve the above problem, the prior art provides a micro close-up shots device to be attached or combined in front of the photographing lens of the electric device such as the mobile phone, so as to magnify the image. However, the micro close-up shots device mainly comprises the housing, the optical lens and the fixed focused tube, and this still uses the passive focusing that is restricted when capturing images within a very short distance.

Therefore, how to provide a close-up shots system and a close-up shots module thereof to capture images within a short distance to overcome the above mentioned defects has become a problem to be solved in this field of art.

### SUMMARY OF THE INVENTION

In order to solve the above problems, the instant disclosure provides a close-up shots system and a close-up shots module thereof for capturing images within a short distance.

One of the embodiments of the instant disclosure provides a close-up shots module, and the close-up shots module is configured to be corresponding to an image capture module of an electric device for capturing an object image. The close-up shots module comprises a liquid lens unit and a control unit. The control unit is electrically connected to the liquid lens unit. The control unit receives a signal sent by the image capture module, and the control unit controls the focal length of the liquid lens unit according to the signal.

The instant disclosure further provides a close-up shots system, and the close-up shots system comprises an image capture module, a close-up shots module and a signal connecting module. The image capture module is configured on an electric device. The close-up shots module is configured on an electric device and to be corresponding to the image capture module. The close-up shots module comprises a liquid lens unit and a control unit, and the control unit is electrically connected to the liquid lens unit. The signal connecting module is electrically connected to the image capture module. The control unit receives a signal sent by the signal connecting module, and the control unit controls the liquid lens unit to tune the focal length for scanning according to the received signal.

To sum up, the close-up shots module provided by the embodiment of the instant disclosure uses the control unit to receive the signal sent by the image capture module, and controls the focal length of the liquid lens unit according to the signal, which provides a better close-up shots function to the image capture module having no close-up shots function or having the close-up shots function that is not good enough.

Moreover, the close-up shots system provided by the embodiment of the instant disclosure makes the close-up shots module thereof and the image capture module in the electric device correspond with each other, and controls and tunes the focal length of the liquid lens unit in the close-up shots module via the signal connecting module that transmits signals between the close-up shots module and the image capture module. Thereby, by using the close-up shots system provided by the embodiment of the instant disclosure, clear images can be captured at correct focal lengths within a short distance.

For further understanding of the instant disclosure, reference is made to the following detailed description illustrating the embodiments and embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of an image capture system of one embodiment of the instant disclosure.

FIG. 2 shows a three dimensional exploded view of an image capture system of one embodiment of the instant disclosure.

FIG. 3 shows a three dimensional assembly drawing of an image capture system of one embodiment of the instant disclosure.

FIG. 4 shows a schematic drawing of the focal length tuning mechanism of one embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of elements may be exaggerated for clarity.

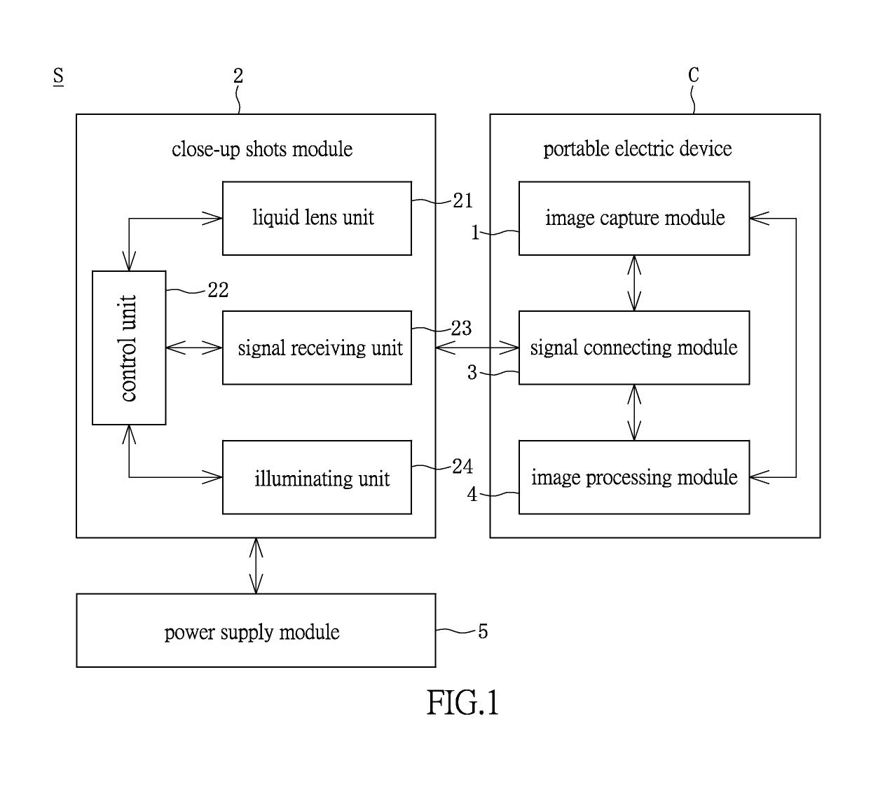

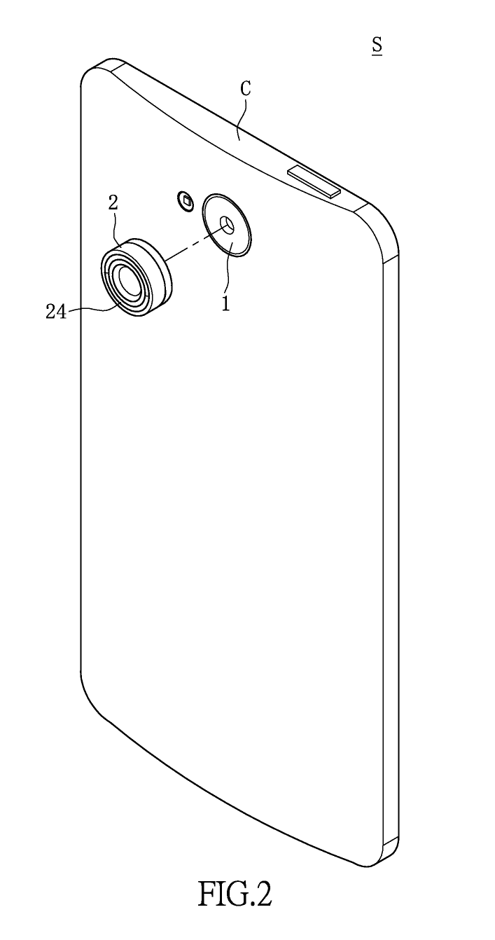

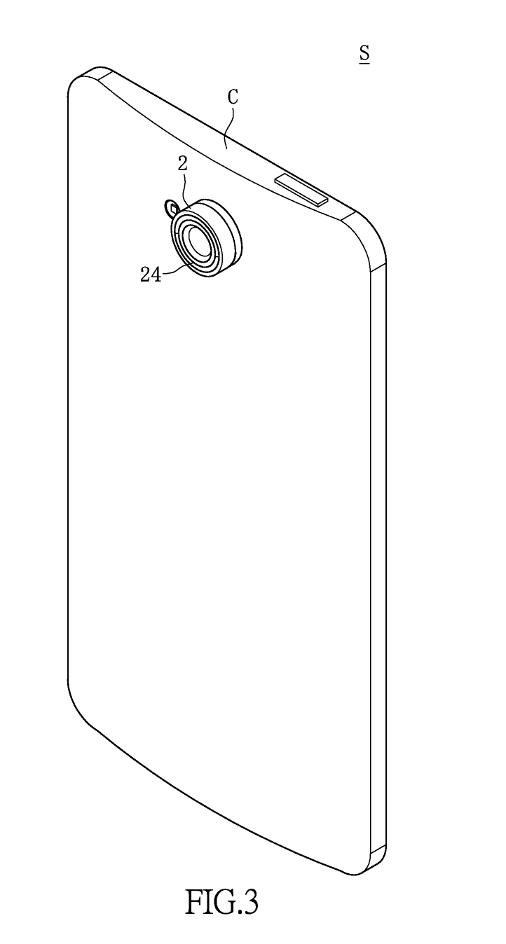

Please refer to FIGS. 1-3. FIG. 1 shows a block diagram of an image capture system of one embodiment of the instant disclosure, FIG. 2 shows a three dimensional exploded view of an image capture system of one embodiment of the instant disclosure, and FIG. 3 shows a three dimensional assembly drawing of an image capture system of one embodiment of the instant disclosure. The embodiment of the instant disclosure provides an image capture system S having the close-up shots function, comprising an image capture module 1, a close-up shots module 2 and a signal connecting module 3. For example, the image capture module 1 could be configured in an electric device C, such as a smart phone, tablet computer, microscope, or the like. The image capture module 1 could be a camera module in an electric device C. For example, the image capture module 1 could be a camera module of the smart phone or the tablet computer, but it is not limited herein. Additionally, it should be mentioned that, the instant disclosure could be particularly applied to an electric device C having the Voice Coil Actuator/Voice Coil Motor as its driver.

According to the above, the close-up shots module 2 could be configured in the electric device C, and the close-up shots module 2 is configured to be corresponding to the image capture module 1. For example, the close-up shots module 2 could be configured at the front end of the image capture module 1. In this case, the close-up shots module 2 could clamp on the electric device C, but it is not limited herein. In other words, the close-up shots module 2 could clamp and be externally mounted on the electric device C, but it is not limited herein. Also, the close-up shots module 2 could be mounted on the electric device C via magnetic suction, adhesion, fastener, bolt connection or other ways.

The close-up shots module 2 can comprise a liquid lens unit 21, a control unit 22 and a signal receiving unit 23. The control unit 22 can be electrically connected to the liquid lens unit 21 to control the liquid lens unit 21. In other words, the control unit 22 gives an instruction to the liquid lens unit 21 based on the need to control the focal length of the liquid lens unit 21. Moreover, the control unit 22 can also be electrically connected to the signal receiving unit 23 to receive the information sent by the signal receiving unit 23 and further to control the liquid lens unit 21. It should be mentioned that, the signal receiving unit 23 can also be configured within the control unit 22. That is, the control unit 22 and the signal receiving unit 23 can be the same module, but it is not limited herein. It is worth mentioning that, the close-up shots module 2 can further comprise an illuminating unit 24, and the illuminating unit 24 can be a ring-shaped light source that is configured at the close-up shots module 2 and the illuminating unit 24 surrounds the liquid lens unit 21. Additionally, the control unit 22 can be electrically connected to the illuminating unit 24 to control the turning on, the turning off and the illumination intensity of the illuminating unit 24, such that the image capture module 1 can capture clearer images within the desirable depth of field via obtaining a better light source.

According to the above, the signal connecting module can be configured on the electric device C, and can be electrically connected to the image capture module 1 to make a signal connection between the close-up shots module 2 and the image capture module 1. For example, the signal connecting module 3 can be a wireless communication module, such as blue-tooth module, the infra-red module or the like. Also, it should be mentioned that, the signal connecting module 3 can be a wired communication module that is electrically connected to the signal receiving unit 23 in the close-up shots module 2 via a cable line.

The image capture system S can further comprise a power supply module 5 that is electrically connected to the close-up shots module 2. The power supply module 5 provides the power to drive the liquid lens unit 21, the control unit 22 and the signal receiving unit 23. For example, as the close-up shots module 2 is wiredly connected to the signal connecting module 3, the power supply module 5 can be a battery in the electric device C. When the close-up shots module 2 is wirelessly connected to the signal connecting module 3, the power supply module 5 can be a battery configured on the close-up shots module 2. That is, the battery could be configured on the clamping element (not shown) of the close-up shots module 2, which clamps on the electric device C, but it is not limited herein.

The control unit 22 in the close-up shots module 2 controls the liquid lens unit 21 to tune the focal length for scanning according to a signal sent by the signal connecting module 3 and received by the signal receiving unit 23. In this embodiment, the close-up shots module 2 is mainly used to tune the focal length. Thus, there is no other image capturing element in the close-up shots module 2. The close-up shots module 2 can be structured as a variable focus lens, to be used with the image capture module 1 on the electric device C. It is worth mentioning that the liquid lens unit can have a predetermined focusing range, and there are plenty of focusing segments set within the predetermined focusing range. It should be mentioned that the focusing segments refer to the focusing ranges that could be captured by the image capture module 1 after the liquid lens unit 21 is tuned. For example, the focusing segments for scanning after the liquid lens unit 21 is respectively tuned are 2 cm˜2.5 cm, 2.5 cm˜3 cm, 3 cm˜4 cm, 4 cm˜6 cm, and the like, but it is not limited herein and depends on the design of the liquid lens unit 21.

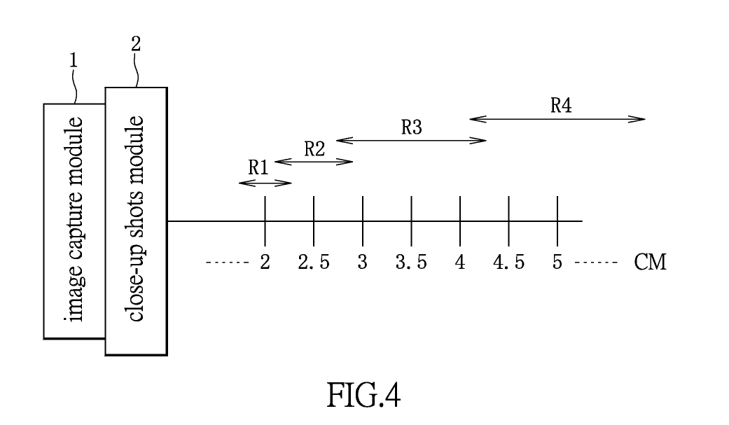

Please refer to FIG. 4. FIG. 4 shows a schematic drawing of the focal length tuning mechanism of one embodiment of the instant disclosure. In FIG. 4, the short vertical line represents the focusing plane, and the horizontal line represents for the depth of field. Generally, the nearer the focusing plane and the image capture module 1 are, the smaller the depth of field is. The more distant the focusing plane and the image capture module 1 are, the larger the depth of field is. In order to focus instantly, in the instant disclosure, the close-up shots module 2 of the liquid lens unit 21 scans the focusing plane, and obtains images at different focusing planes that are from far to near, or from near to far. A properly designed tuning value of the liquid lens unit 21 makes the continual images have the predetermined depths of field. For example, R1 of the depth of field 1 represents the depth of field when the focal length is 2 cm, R2 of the depth of field 2 represents for the depth of field when the focal length is 2.5 cm, R3 of the depth of field 3 represents for the depth of field when the focal length is 3.5 cm, and R4 of the depth of field 4 represents for the depth of field when the focal length is 5 cm. The liquid lens unit 21 can tune the focal length to be from large to small or from small to large for scanning. Also, the time consumption for tuning the focusing plane is smaller than 10 ms, so the image scanning can be finished fast, and the image capture module 1 can capture images fast during the tuning and scanning process.

From the above, preferably, the image capture system S provided by the embodiment of the instant disclosure can further comprise an image processing module 4, and the image processing module 4 can be configured on the electric device 3. The signal connecting module 3 can be electrically connected to the image processing module 4 to receive the information sent by the image processing module 4.

Specifically speaking, the image processing module 4 obtains a clear image among the continual images captured at different focal lengths of the liquid lens unit 21 during the tuning and scanning process by the image capture module 1. In other words, the liquid lens unit 21 captures a plurality of continual images at different focal lengths of the liquid lens unit 21 during the tuning and scanning process, and the image processing module 4 obtains a clear image among the continual images captured by the image capture module 1. Thereby, when the signal connecting module 3 and the close-up shots module 2 have the signal connection, the image processing module 4 can determine whether there is a clear image at the currently tuned focal length of the liquid lens unit 21. For example, the control unit 22 can control the liquid lens unit 21 to scan from a far place to a near place. The image tuning can be finished fast because the time consumption for tuning the focusing plane of the liquid lens unit 21 is rather small.

Additionally, it should be mentioned that, in other embodiments, the liquid lens unit 21 can tune the focal length by single-time focal length tuning, continual focal length tuning, single-time focal length tuning within a predetermined range or continual focal length tuning within a predetermined range. That is, by the instruction given by the control unit 22, the liquid lens unit 21 tunes the focal length by single-time focal length tuning within a plurality of focusing segments in a predetermined range, to change the focal length of the image capture module 1. For example, the control unit 22 gives an instruction to tune the focal length by single-time focal length tuning, and thus the liquid lens unit 21 has a predetermined curvature. After that, a user moves the position of the electric device C to capture images. Moreover, the liquid lens unit 21 can tune the focal length by continual focal length tuning within a plurality of focusing segments in a predetermined range according to the instruction given by the control unit 22, such that the focal length of the image capture module can be continually and repeatedly tuned within the predetermined focusing range, until the control unit 22 gives the instruction to stop the tuning. For example, via the continual focal length tuning, the control unit 22 continually gives instructions to drive the liquid lens unit 21 to change its curvature, to continually change the focal length of the image capture module 1. More precisely, based on the instruction given by the control unit 22, the liquid lens unit 21 tunes the focal length by the single-time focal length tuning within the predetermined range in the predetermined focusing range. That is, the liquid lens unit 21 could only scan certain focusing segments and tune the focal length by the single-time focal length tuning within a predetermined range in the predetermined focusing range. After that, the use moves the position of the electric device C to capture images. Additionally, based on the instructions given by the control unit, the liquid lens unit 21 tunes the focal length by the continual focal length tuning within a predetermined range in the predetermined focusing range. In other words, the control unit 22 can continually give instructions to the liquid lens unit 21 for tuning the focal length of the liquid lens unit 21 according to the image change of the image capture module 1. Thus, the focal length of the image capture module 1 can be continually and repeatedly tuned within a predetermined range in the predetermined focusing range, such that the focal length of the image capture module 1 can be continually changed. Moreover, in other embodiments, during the period that the liquid lens unit 21 continually tunes the focal length, and during the period that the liquid lens unit 21 tunes the focal length by the continual focal length tuning within a predetermined range in the predetermined focusing range, the focal length can be continually and repeatedly tuned. For example, the focal length is tuned between the smaller depth of field and the larger depth of field such that the images can be captured at proper focal lengths by the image capture module.

In addition, during the process of tuning focal length, the image capture module 1 can continually capture a plurality of images at different focusing planes at the same time, and transmit the captured images instantly to the image processing module 4. Moreover, it should be mentioned, the image capture module 1 can capture every image at each of the different focusing planes, or could capture several images at several different focusing planes. Specifically speaking, when the focal length of the liquid lens unit 21 is properly tuned, the image processing module 4 can determine if there is a clear image captured by the image capture module 1, and the position where the clear image is captured represents the proper focal length. Additionally, the image capture module 1 can automatically focus when there is a close-up shots module 2 in front of the image capture module 1.

From the above, the image processing module 4 can choose an image that is clear or properly focused among the continual images captured at different focal lengths sent by the image capture module 1. For example, the image processing module 4 can calculate the contrast value and the sharpness value of the image by using the Modulation Transfer Method (MTF) as the image definition algorithm based on the concept of the lens resolution, and further determine where the properly focused image that is clear would be obtained and obtain the proper focal length. In other words, if the edge of the images that are captured at different focal lengths by the image capture module apparently changed, as the difference of the gray level value or the slope between the adjacent pixels is larger, the captured image would be clearer. Based on these features, after the images captured by the image capture module 1 are processed by the image processing module 4, the information of the standard sharpness value can be obtained. If the blurred image is also obtained because there are insufficient high frequency signals in the image and more low frequency signals, the image high frequency information could be obtained as the determination standard via the frequency-domain filtering method using the high-pass filter. For example, in this embodiment, the image processing module 4 could be a Microcontroller Unit (MCU) or the operation unit in the electric device, such as the Central Processing Unit (CPU), but it is not limited herein. Also, during the period when the image processing module 4 determines whether the captured image is clear, the image processing module 4 outputs a signal to the image processing module 23 to make the control unit 22 control the liquid lens unit 21 to change the focal length and to further tune the curvature of the liquid lens unit 21. In addition, in the above process, the image capture module 1 can automatically focus when there is a close-up shots module 2 configured in front of the image capture module 1. It is worth mentioning that when the image capture module 1 captures images, the image processing module 4 can record the object distance information in the clearly captured image to determine the distance between the lens and each object in the clear image.

According to the above, the control unit 22 can make the image capture module 1 obtain a clear image according to the information received by the signal connecting module 3 In other words, when the electric device is moved, the control unit 22 can make the liquid lens unit maintain focused. To be precise, during the tuning and scanning process of the liquid lens unit 21, there must be one distance that is the proper focal length. Thus, when the signal connecting module 3 and the close-up shots module 2 have a signal connection, the image processing module 4 could determine whether there is a clear image at the focal length currently tuned by the liquid lens unit 21. More precisely, when the user moves the electric device C, the focal length of the clear image would also change. The image processing module 4 can determine whether the image captured by the image capture module is clear at the focal length currently tuned by the liquid lens unit 21. If there is no clear image captured by the image capture module at the focal length currently tuned by the liquid lens unit 21, the image processing module 4 transmits the information to the signal connecting module 3. The signal connecting module 3 transmits a signal to the signal receiving unit 23 in the close-up shots module according to the received information. The control unit 22 controls the liquid lens unit 21 to tune the focal length according to the information received by the signal receiving unit 23. That is, the control unit 22 continues to tune the focal length of the liquid lens unit 21 according to the information of the image processing module 4. For example, as mentioned above, based on the contrast value and the sharpness value, a clear image can be determined. In other words, the image processing module 4 can continue to determine whether the currently captured image is a clear image, and continue to tune the focal length of the liquid lens unit 21.

Moreover, when the focal length of the liquid lens unit 21 is tuned, the image processing module 4 can simultaneously record the continual images and the focal length information to do the focus stacking, but it is not limited herein.

To sum up, via the close-up shots system and the close-up shots module S thereof in the embodiments of the instant disclosure, the close-up shots module 2 is configured to correspond to the image capture module 1 on the electric device C. Via the signal connecting module 3 that transmits signals between the close-up shots module 2 and the image capture module 1, the focal length of the liquid lens unit 21 in the close-up shots module 2 can be tuned. Thereby, a clear and properly focused image is obtained even within a short distance.

The traditional electric device C has a predetermined range of the depth of field, so it is hard to properly focus when capturing images within a short distance. However, via the close-up shots module 2 provided by the embodiments of the instant disclosure, the range of the depth of field of the electric device can be extended.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

1. A close-up shots module, configured to be corresponding to an image capture module of an electronic device, comprising:
a liquid lens unit and a control unit, wherein the control unit is electrically connected to the liquid lens unit;
wherein the control unit receives a signal sent by the image capture module, and the control unit controls the focal length of the liquid lens unit according to the signal;
wherein the close-up shots module is externally mounted on the electronic device to correspond to the image capture module;
wherein the electronic device is a smart phone or a tablet computer;
wherein the electric device includes a Voice Coil Actuator or a Voice Coil Motor as the image capture module's driver;
wherein the image capture module is camera module of the electronic device;
wherein the focal length of the liquid lens unit is 2 cm˜6 cm.

2. The close-up shots module according to claim 1, further comprising an illuminating unit, the control unit electrically connected to the illuminating unit to control the turning on, the turning off and the illumination intensity of the illuminating unit, wherein the illuminating unit is a ring-shaped light source and surrounds the liquid lens unit.

3. The close-up shots module according to claim 1, wherein the liquid lens unit has a predetermined focusing range, the liquid lens unit tuning the focal length by single-time focal length tuning, continual focal length tuning, single-time focal length tuning within a predetermined range or continual focal length tuning within a predetermined range.

4. The close-up shots module according to claim 3, wherein the liquid lens unit executing the single-time focal length tuning within the predetermined focusing range.

5. The close-up shots module according to claim 3, wherein the liquid lens unit executing the continual focal length tuning within the predetermined focusing range.

6. The close-up shots module according to claim 3, wherein the liquid lens unit executing the single-time focal length tuning within a predetermined range of the predetermined focusing range.

7. The close-up shots module according to claim 3, wherein liquid lens unit executing the continual focal length tuning within a predetermined range of the predetermined focusing range.

8. A close-up shots system, comprising:
an image capture module, configured on an electronic device, wherein the electronic device is a smart phone, a tablet computer, or a microscope, wherein the electric device includes a Voice Coil Actuator or a Voice Coil Motor as the image capture module's driver, wherein the image capture module is camera module of electronic device;
a close-up shots module, externally mounted on the electronic device to correspond to the image capture module, wherein the close-up shots module comprises a liquid lens unit and a control unit, and the control unit is electrically connected to the liquid lens unit; and
a signal connecting module, electrically connected to the image capture module;
wherein the control unit receives a signal sent by the signal connecting module, and the control unit controls the liquid lens unit to tune the focal length for scanning according to the received signal;
wherein the focal length of the liquid lens unit is 2 cm˜6 cm.

9. The close-up shots system according to claim 8, wherein
the close-up shots module comprises an illuminating unit, and the control unit is electrically connected to the illuminating unit to control the turning on, the turning off and the illumination intensity of the illuminating unit, wherein the illuminating unit is a ring-shaped light source and surrounds the liquid lens unit.

10. The close-up shots system according to claim 8, further comprising a power supply module, the close-up shots module further comprising a signal receiving unit, the power supply module electrically connected to the close-up shots module, and providing the power to drive the liquid lens unit, the control unit and the signal receiving unit.

11. The close-up shots system according to claim 8, further comprising an image processing module, the image processing module configured on the electric device, the signal connecting module electrically connected to the image processing module to receive an information sent by the image processing module.

12. The close-up shots system according to claim 8, the close-up shots module further comprising a signal receiving unit, wherein the signal receiving unit is electrically connected to the control unit.

13. The close-up shots system according to claim 8, wherein the liquid lens unit has a predetermined focusing range, the liquid lens unit tuning the focal length by single-time focal length tuning, continual focal length tuning, single-time focal length tuning within a predetermined range or continual focal length tuning within a predetermined range.

14. The close-up shots system according to claim 13, wherein the liquid lens unit executing the single-time focal length tuning within the predetermined focusing range.

15. The close-up shots system according to claim 13, wherein the liquid lens unit executing the continual focal length tuning within the predetermined focusing range.

16. The close-up shots system according to claim 13, wherein the liquid lens unit executing the single-time focal length tuning within a predetermined range of the predetermined focusing range.

17. The close-up shots system according to claim 13, wherein liquid lens unit executing the continual focal length tuning within a predetermined range of the predetermined focusing range.
